(19) United States
(12) Patent Application Publication
(10) Pub. No.: US 2008/0005239 A1
(43) Pub. Date: Jan. 3, 2008

(54) System and method for capturing collaborative data at a multi-function peripheral (MFP)

(76) Inventor: Brian Podl, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/478,262

(22) Filed: Jun. 28, 2006

(51) Int. Cl. G06F 15/16

(52) U.S. Cl. 709/204

(57) ABSTRACT

A system and method for capturing collaborative data at a multi-function peripheral (MFP) are disclosed. In one aspect, the method comprises recording at a MFP data indicative of a communication between or among a plurality of meeting participants. Each meeting participant has an associated device to transmit data to others and to receive data transmitted from others. A copy of the transmitted data is provided to the MFP for recording when one of the meeting participants transmits data to other meeting participants.

### BACKGROUND OF THE INVENTION

1. Field of the Invention

The invention relates to the operation of a multiple function peripheral (MFP) device. More particularly, the invention relates to recording a meeting utilizing a MFP device.

2. Description of the Related Technology

The existing MFPs do not have the capability to record meetings. In order to use a MFP to process data communicated during a meeting, a user would have to use an external device to record the meeting and then transmit the recorded meeting to the MFP for further processing. For a computerized Internet meeting, a user would have to save a recording or log of the meeting with one of the computers. In order to print the meeting log, the user would have to have a printer driver installed and be connected to the MFP in a way that enables printing. In the case of a short message service (SMS) conversation, the user would have to manually compile the messages into a document that may then be saved, printed, emailed or faxed. Cell phones do not provide a direct and easy way to log an entire SMS text message session of many messages. A voice meeting would have to be recorded using a telephone recording device. After such a recording, the user may not be able to easily distribute the recorded voice meeting. Therefore, it is desirable to add integrated meeting recording capability in a MFP and give the user the ability to archive or distribute the recorded meeting by saving, printing emailing and/or faxing the recorded data.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be briefly discussed.

In one aspect, there is a method of processing, at a multi-function peripheral (MFP), a meeting among a plurality of meeting participants. The method comprises, at a MFP, recording data indicative of a communication between or among a plurality of meeting participants, each meeting participant having an associated device to transmit data to others and to receive data transmitted from others, wherein a copy of the transmitted data is provided to the MFP for recording when one of the meeting participants transmits data to other meeting participants.

In another aspect, a multi-function peripheral (MFP) device is configured to record a meeting among a plurality of meeting participants, each meeting participant having an associated device to transmit data to others and to receive data transmitted from others. The device comprises an input interface for receiving data from a user, a display for providing information to the user, a communication module configured to receive data transmitted from the meeting participants during the meeting via a communication link, and a control unit executing a software application to control the input interface and the display to realize user interaction and to record data received from the communication module, wherein a copy of the transmitted data is provided to the MFP for recording when one of the meeting participants transmits data to other meeting participants, and wherein a composite of recorded communications is saved as a recorded meeting at the MFP.

In another aspect, a multi-function peripheral (MFP) device is configured to record a meeting among a plurality of meeting participants, each meeting participant having an associated device to transmit data to others and to receive data transmitted from others. The device comprises means for receiving data transmitted from the meeting participants during a meeting and means for recording the received data at the MFP, wherein a copy of the transmitted data is provided to the MFP for recording when a meeting participant transmits data to other meeting participants.

### BRIEF DESCRIPTION OF THE DRAWINGS

FIG. 1 is an overview illustrating one embodiment of a system in which a multi-function peripheral (MFP) device is connected to various devices to record meetings.

FIG. 2 is a block diagram illustrating one embodiment of the MFP device as illustrated in FIG. 1.

FIG. 3 is a flowchart of one embodiment of a method of recording a meeting among a plurality of meeting participants at a MFP device.

FIG. 4 is a flowchart of another embodiment of a method of recording a meeting among a plurality of meeting participants at a MFP device.

FIG. 5 is a diagram illustrating an example MFP menu by which a user may operate the MFP to record an Internet chat meeting.

FIG. 6 is a diagram illustrating an example MFP menu by which a user may edit meeting lists when operating the MFP to record a meeting held via SMS test messages.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the technology that the disclosed systems and methods may be practiced without these specific details. For example, electrical components may be shown in block diagrams in order not to obscure certain aspects in unnecessary detail. In other instances, such components, other structures and techniques may be shown in detail to further explain certain aspects.

It is also noted that certain aspects may be described as a process, which is depicted as a flowchart, a flow diagram, a structure diagram, or a block diagram. Although a flowchart may describe the operations as a sequential process, many of the operations may be performed in parallel or concurrently and the process may be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The purpose of certain embodiments is to provide integrated meeting recording capabilities in a MFP, and give the user the ability to archive or distribute the recorded meeting easily by, for example, saving, printing emailing and/or faxing the recorded data. The MFP may be used to save chat messages from an Internet chat room, SMS text messages, telephone conference calls or other meeting data. The MFP may “listen” to the meeting and save the text or voice data. The MFP may be invited to an existing Internet chat room as a participant or the MFP may provide Internet meeting services built in for capturing an Internet chat session. The MFP may intercept SMS text messages and log the data. After the meeting is over, the meeting log may be printed, emailed or saved. This feature may also work to record telephone conference meetings. The voice data may be saved internally in the MFP and emailed or saved as an external audio file. The feature allows the MFP to be set to record all text messages going back and forth between meeting participants and instantly provide a log that may be printed, emailed or saved. One advantage provided by these embodiments is that the meeting data is centralized to the MFP and may be easily printed and/or distributed via email and/or fax. A computer is not needed to access the meeting data. The user may directly print, save, email and/or fax or otherwise distribute or copy the recorded meeting data from the MFP.

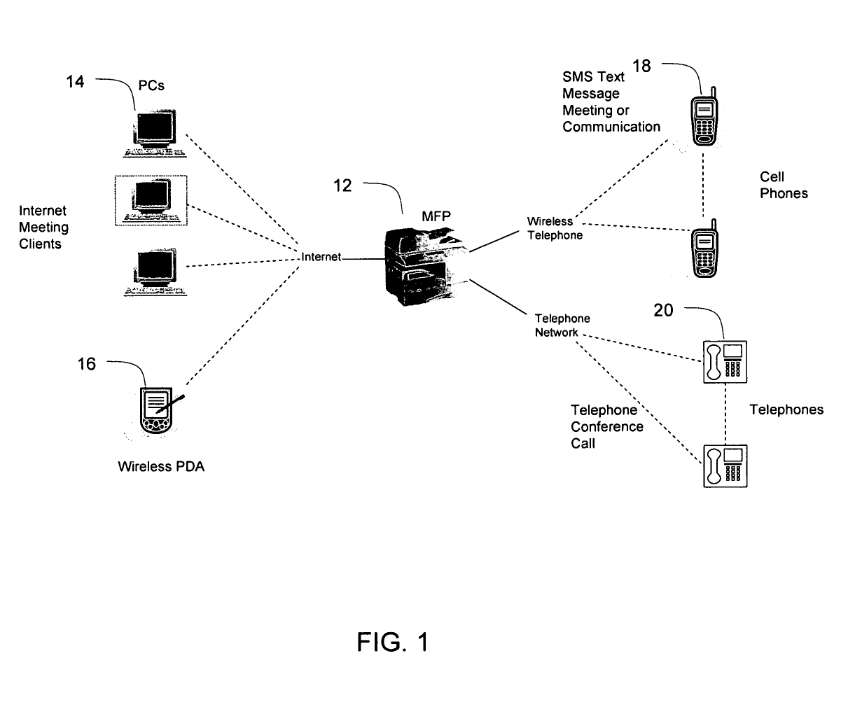

FIG. 1 is an overview illustrating one embodiment of a system in which a multi-function peripheral (MFP) device 12 is connected to various devices to record meetings. A MFP refers to an equipment connectable to a personal computer (PC) or network that handles two or more of the following functions: printing, emailing, copying or faxing. It is also called a multi-function product, a multi-function printer, a multi-function device, an All-in-One device, etc.

During a meeting, two or more users (“meeting participants”) are electronically connected to each other. Each meeting participant uses a device to send communications to and receive communications from other meeting participants. The MFP device 12 is connected to the devices used by the meeting participants and act as a recorder of the meeting. Each time a meeting participant sends a communication to other meeting participants, the MFP device 12 receives and saves a copy of the communication. The communication may be, for example, text, voice, image, video, spreadsheet, short text message, audio or multimedia data. A log of the communications is stored on the MFP during the meeting. At the conclusion of the meeting, the log of the meeting, i.e., a composite of the communications recorded during the meeting, may be printed, stored, emailed or faxed, or otherwise copied or distributed, to one or more recipients.

The MFP device may be configured to record various kinds of meetings. In one embodiment, the meeting participants use PCs 14 or wireless PDAs 16 to connect to an Internet chat room to hold the meeting. The MFP device 12 is connected via Internet to the chat room and saves chat messages entered by the meeting participants. In another embodiment, the meeting participants use the short message service (SMS) text message via wireless telephones 18 to communicate to each other. The MFP device 12 is connected to the wireless telephone network and records the short messages sent by meeting participants. In another embodiment, the meeting participants use conference calls via telephones 20 to communicate to each other. In that case, the MFP device 12 is connected to meeting participants via the telephone network and records the received voice data. In another embodiment, the MFP 12 may be configured to record video data exchanged during a video conference call and save it in a video file format. In another embodiment, the MFP 12 may be configured to record person-to-person meetings. In some embodiments, the devices used by meeting participants to communicate with each other may be other devices rather than SMS text client, Internet chat client or telephone. Traditional paging devices, walkie-talkie, Bluetooth headset device are but some examples of a variety of communication devices that may be used.

In some embodiments, the MFP may be capable of forwarding recorded meeting data to another MFP. The forwarded data may be the entire meeting data or some portion of the data including raw or formatted text messages, Internet chat messages or audio data. In some embodiments, several MFPs connected together may collect the meeting information and collaborate together to compile a meeting log. In some embodiments, the MFP 12 may be configured to work as a device used by a meeting participant to communicate to other meeting participants and a meeting recording device simultaneously.

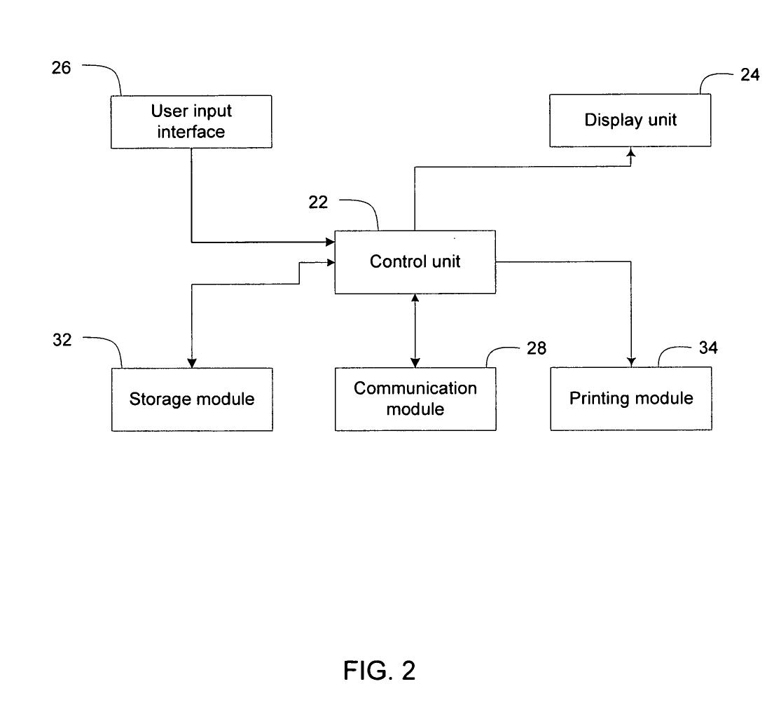

FIG. 2 is a block diagram illustrating one embodiment of the MFP device 12 as illustrated in FIG. 1. The MFP device 12 comprises a communication module 28 configured to connect to and communicate with the devices used by meeting participants. In some embodiments, the communication module 28 may comprise multiple sub-modules in order to support various types of meeting devices. The communication module 28 may comprise, for example, telephone interface, Ethernet interface, WiFi, etc. The communication module 28 may also be used to distribute copies of the recorded meeting communications from the MFP to other parties.

In some embodiments, the MFP device 12 may further comprise a user input interface 26 and a display unit 24 to enable user interaction. The display unit 24 is used to communicate information, instructions, or data to a user. The user input interface 26 is configured to receive input data or instruction from a user.

Both the display unit 24 and the user input interface 26 may be implemented in many forms and may contain multiple components. In one embodiment, the display unit 24 may be, for example, a LCD. The user input interface 26 may include a keypad or keyboard. In other embodiments, the user input interface 26 and the display unit 24 may be integrated together in one device such as a touch screen as incorporated in a panel of certain copy machines.

Both the display unit 24 and the user input interface 26 may be an integral part of, or an external device connected to, the MFP device 12. In certain embodiments, both the display unit 24 and the user input interface 26 are connected to a computer which is connected to the MFP device 12 through a communication link. In that case, the MFP device 12 interacts with the user through the computer.

The MFP device 12 may further comprise a control unit 22 configured to control the operation of the device 12. In one embodiment, the control unit 22 is a processor which may be any suitable general purpose single- or multi-chip microprocessor, or any suitable special purpose microprocessor such as a digital signal processor, microcontroller, or a programmable gate array. As is conventional, the processor may be configured to execute one or more software applications. In certain embodiments, the control unit 22 runs a software application in communication with other components of the MFP device 12. For example, the control unit 22 may be configured to control the user input interface 26 and the display unit 24 to realize user interaction and to record data received from the communication module 28.

The MFP device 12 may also comprise a storage module 32 to store data, for example, the communications received from meeting participants during the meeting. The storage module 32 may be an integral part of, or an external device connected to, the device 12. In certain embodiments, the storage module 32 comprises a persistent data storage device, which is configured to keep the data or its contents regardless of the power being turned off or if the storage device is moved to another computer. In one embodiment, the storage module 32 is an internal hard drive. In another embodiment, the storage module 32 may be any kind of flash storing media, for example, a compact flash card. In certain embodiments, the storage module 32 may comprise a volatile data storage device, for example, the memory of a PC, to temporarily save the communications received by the communication module 28 during the meeting.

In some embodiments, the MFP device 12 may further comprise a printing module 34 configured to print the whole or a portion of the recorded meeting. Other like copying modules may be included, for instance, a writeable DVD module.

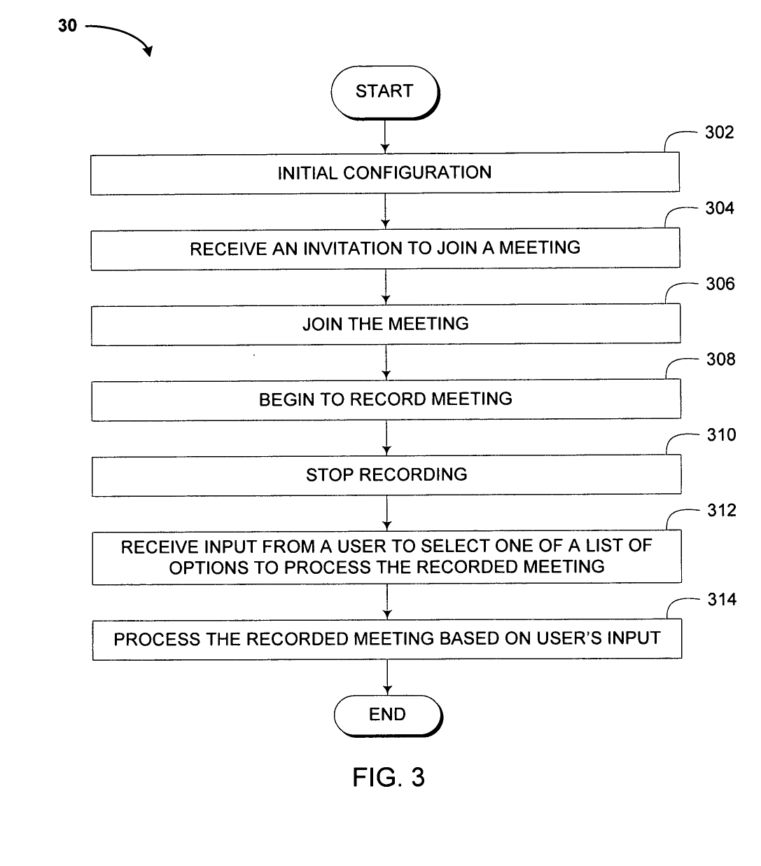

FIG. 3 is a flowchart of one embodiment of a method of recording a meeting among a plurality of meeting participants at a MFP device 12. Depending on the embodiment, certain steps of the method may be removed, merged together, or rearranged in order. The general principle of the exemplary method will be described first as below.

The method begins at a block 302, where the MFP device 12 is initially configured. The initial configuration depends on the meeting devices that the MFP device 12 will be connected to. For example, the initial configuration may comprise establishing a MFP Internet chat ID for the MFP device 12 when the MFP device 12 is to be connected to an Internet chat meeting.

Next at a block 304, the MFP device 12 receives an invitation to join a meeting. In some embodiments, the invitation is received via the communication module 28 from a meeting participant. Moving to a block 306, the MFP device joins the meeting by accepting the invitation. The MFP device 12 joins the meeting when it is connected to one or more meeting participants. The MFP may be configured to automatically accept the invitation. The MFP may require confirmation from a user of the MFP via the user input interface 26 through a menu before accepting the invitation. The MFP may accept the invitation if it determines that a set of pre-determined conditions is met, for example, the invitation is from a user device whose identification is in a list stored at the MFP device 12. In certain applications, the process of blocks 304 and 306 may be replaced by a different process. For example, the MFP 12 may be configured to establish the meeting with the MFP as a meeting participant and then invite other meeting participants to join the meeting.

Next at a block 308, the MFP device 12 begins to record the communications received from other meeting participants. The MFP may be instructed to begin recording by a user via the user input interface 26, or by a meeting participant. The MFP device 12 receives a copy of a communication when a meeting participant sends the communication to other meeting participants.

Moving to a block 310, the MFP device 12 stops recording. The MFP may be configured to automatically stop recording when it is the last meeting participant in the meeting. The MFP may also be instructed to stop recording by a user via the user input interface 26, or by a meeting participant. Recording may also be programmed for a set period of time, for example.

Next at a block 312, the MFP 12 receives input from a user of the MFP to select one of a list of options to process the recorded meeting. The MFP 12 is configured to display a menu listing options for a user to choose from. The user selection may be received from a user of the MFP via the user input interface 26 or via the communication module 28. The recorded meeting here refers to a composite of at least a portion of the recorded communications during the meeting. The list of options depends on the data format of the recorded communications. For text data, the user may choose to print, email, or fax the whole or a part of the recorded meeting. For voice data, the user may choose to save or email an audio file. Of course, other mechanisms for copying and distribution are possible, depending on the capabilities of the MFP.

Moving to a block 314, the MFP 12 processes the recorded meeting based on the input it receives. The whole or a portion of the recorded meeting may be emailed or faxed via the communication module 28, or printed via the printing module 34, or saved into one computer-readable file at the storage module 32. In some embodiments, the recorded meeting may be saved into more than one file.

The general principle of the method as described above may be applied in various applications to record different types of meetings. In the following, two examples will be used to illustrate how the method may be used to record an Internet chat meeting and telephone conference calls. It will be appreciated that the method may be applied similarly to other types of meeting communications.

In the first example, the method 30 is used to record a meeting wherein the meeting participants connect to an Internet chat room to hold the meeting. During the initial configuration of a block 302, the MFP device 12 is set up and a MFP Internet chat identification (ID) is established for the MFP. Common Internet chat room service providers such as Yahoo, AOL, MSN or proprietary services may be utilized for an Internet meeting.

Next at a block 304, the MFP device 12 receives an invitation to enter an existing Internet chat room as a meeting participant. Moving to a block 306, where the MFP joins the meeting by accepting the invitation and being connected via Internet to the chat room where the meeting is held. The MFP may be configured to automatically accept the invitation. The MFP may also require confirmation from a user of the MFP via the user input interface 26 through a menu before accepting the invitation accept the invitation. The MFP may also accept the invitation if it determines that a set of pre-determined conditions is met, for example, the Internet chat ID of the device sending the Internet chat invitation is in a list stored at the MFP 12. In other embodiments, the process of blocks 304 and 306 may be different. For example, the MFP 12 may be configured to provide Internet meeting service. In that case, the MFP 12 may establish a chat room with the MFP as a meeting participant and then invite other meeting participants to the chat room.

Next at a block 308, the MFP device 12 begins to record the meeting. The MFP device 12 records each Internet chat message entered by meeting participants in the chat room. Moving to a block 310, the MFP stops recording. The MFP may be configured to automatically stop recording when it is the last meeting participant in the chat room. The MFP may also be instructed to stop recording by a user via the user input interface 26, or by a meeting participant. As another example, the recording may stop when a particular user is determined to not be communicating after a set period of time.

Next at a block 312, the MFP 12 receives input from a user of the MFP to select one of a list of options to process the recorded meeting. Since the recorded communications during the meeting are text data, the options here may include at least one or more of the following: print, save, email, and fax. Moving to a block 314, the MFP 12 processes the recorded meeting based on the input it received. Furthermore, a user may have limited access rights for the log and thus be able to only selectively access the log.

In the second example, the method 30 is used to record a meeting wherein the meeting participants hold the meeting via telephone conference calls. During the initial configuration of block 302, the MFP 12 is set up in a telephone voice meeting record mode. Next at a block 304, the MFP receives a telephone call from one of the meeting participants. Moving to a block 306, the MFP joins the meeting by, for example, automatically picking up the phone call.

Next at a block 308, the MFP device 12 begins to record the meeting. The MFP device 12 may be configured to automatically begin recording the conference call after picking up the phone call. The MFP device 12 may be configured to begin recording when it receives directions to do so, from either a meeting participant via the communication module 28 or a user at the MFP via the user input interface 26. The MFP 12 records the conference call and stores it in audio format.

Moving to a block 310, the MFP stops recording. The MFP may be configured to automatically stop recording when it detects that the phone call is ended. The MFP may be instructed to stop recording by a user via the user input interface 26. The MFP may be instructed to stop recording by a meeting participant, for example, when he enters number commands on his telephone keypad.

Next at a block 312, the MFP 12 receives input from a user of the MFP to select one of a list of options to process the recorded meeting. Since the recorded communications during the meeting comprise voice data, the options here may comprise at least one or more of the following: save and email. Moving to a block 314, the MFP 12 processes the recorded meeting based on the input it receives. For example, the composite of recorded communications may be saved into one audio file. The audio file may then be selectively emailed to other users with or without encryption.

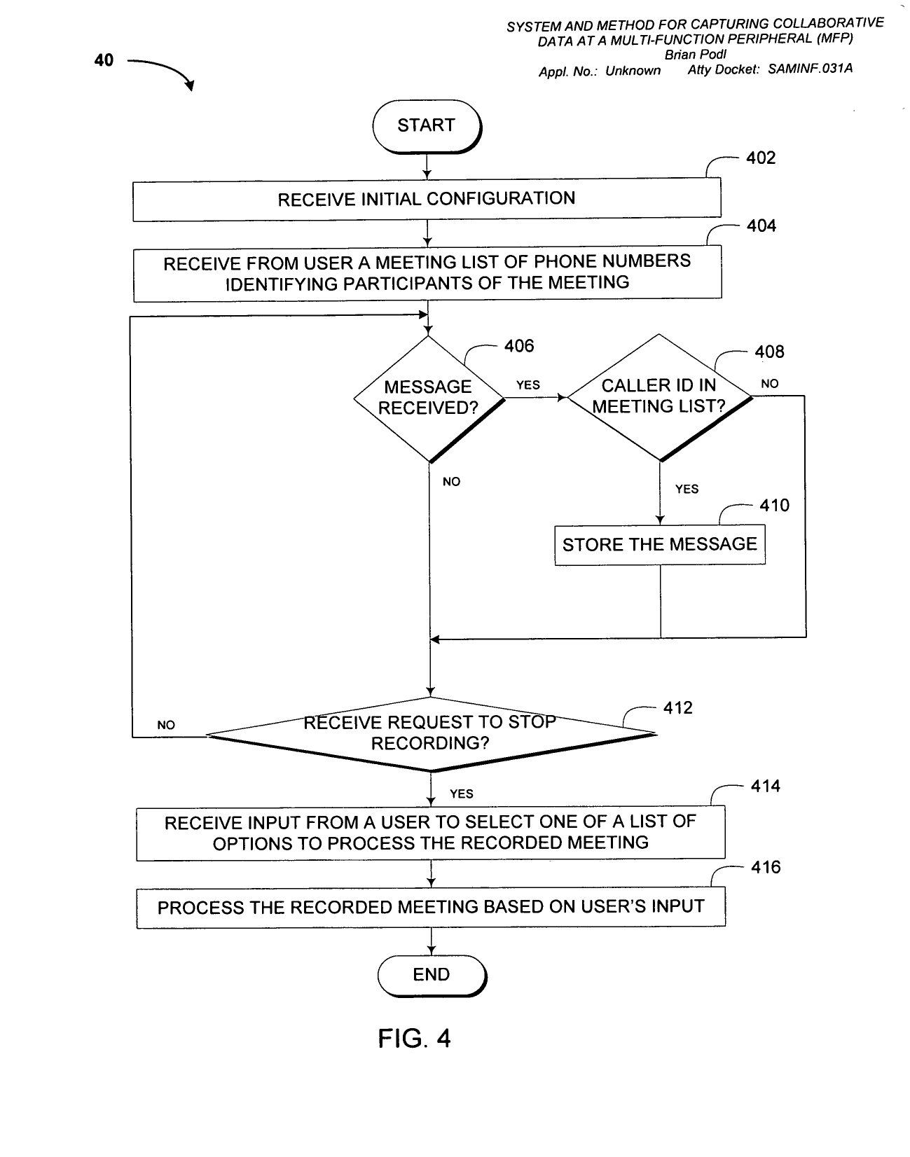

FIG. 4 is a flowchart of another embodiment of a method of recording a meeting among a plurality of meeting participants at a MFP device 12. In the exemplary embodiment, the meeting participants use the short message service (SMS) test message via wireless telephones 18 to communicate to each other. The MFP is added as a recipient for the meeting participants such that it may record SMS text communications between meeting participants during a meeting. Depending on the embodiment, certain steps of the method may be removed, merged together, or rearranged in order.

The method 40 begins at a block 402, where the MFP device 12 is initially configured. In the exemplary embodiment, the initial configuration comprises setting up the MFP and establishing service with a SMS text provider.

Next at a block 404, the MFP device 12 receives a list of caller identifications (IDs), for example, phone numbers, identifying participants of a meeting from a user via the user interface 26. The list of caller IDs indicate from which caller the MFP 12 may accept message. In some embodiments, the MFP device 12 may be configured to record multiple meetings simultaneously. For each meeting, a corresponding list of caller IDs identifying the participants is stored at the MFP.

Moving to a block 406, the MFP device 12 decides whether a SMS text message is received. The method moves to a block 408 if a message is received; otherwise, the method moves to a block 412.

At block 408, the control unit 22 determines whether the caller ID of the party which sends the message is in at least one of the meeting lists stored at the MFP device 12. The control unit 22 may read the caller ID from the received message. The method moves to a block 410 if the caller ID is in one of meeting lists; otherwise, the method moves to a block 412.

At a block 410, the message is stored at the MFP device 12. Since multiple meetings may be recorded simultaneously, the meeting to which the message belongs to is identified by determining which meeting list comprises the caller ID. The MFP device 12 then stores the message, associating the message to the identified meeting.

Next at a block 412, the MFP device 12 determines whether it receives a request to stop recording, via either a user of the MFP or a meeting participant. If no request is received, the method moves back to block 406; otherwise, the method moves to a block 414.

At block 414, the MFP 12 receives input from a user of the MFP to select one of a list of options to process the recorded meeting communications. For example, the options here may comprise at least one or more of the following: print, save, fax, and email. Moving to a block 416, the MFP 12 processes the composite of the recorded SMS text messages based on the input it received. The whole or a portion of the recorded text messages may be emailed or faxed via the communication module 28, or printed via the printing module 34, or saved into one computer-readable file at the storage module 32.

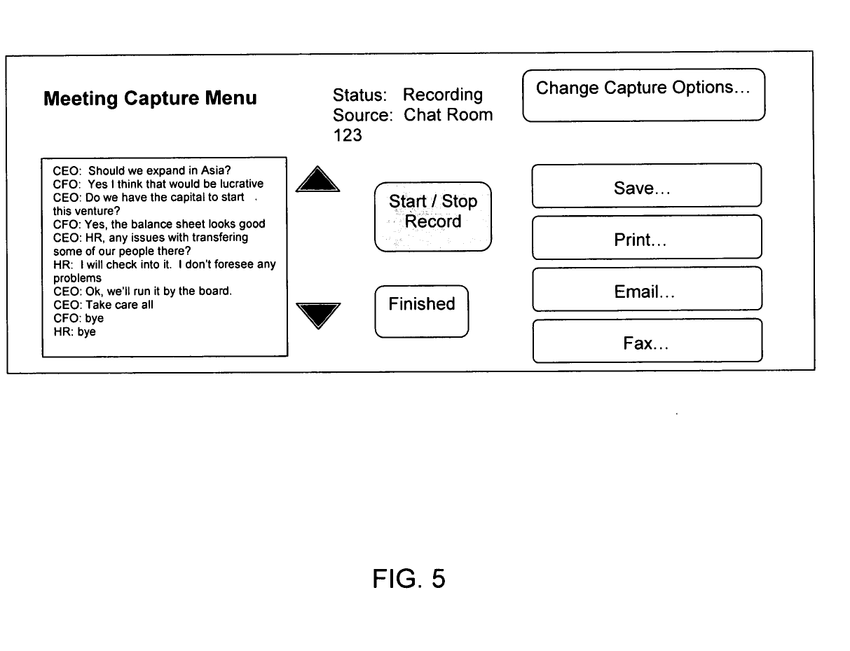

FIG. 5 is a diagram illustrating an example MFP menu by which a user may operate the MFP to record Internet chat meeting. The menu may be displayed by the display unit 24 (see FIG. 2). The exemplary menu may have a display of the captured message text with the ability to scroll through it. The menu may also comprise a display of the status of the MFP and the source of the meeting. A user of the MFP may start or stop recording, or finish the recording.

In some embodiments, the menu may further comprise a Change Capture Option sub-menu. This sub-menu is used to setup the initial configuration for meeting capture. Once clicking on this sub-menu, the user may be able to choose one of the popular Internet chat services, to accept or reject meeting invitations, to select the current meeting being captured for display on the top menu, and to choose from more chat features such as built in messaging, etc.

In some embodiments, the menu may further comprise a set of sub-menus such as Save, Print, Email, and Fax. These sub-menus would be used to direct the recorded text data to a destination. The user may choose any combination of prestored or newly entered destinations. The Save sub-menu would provide a way to save the recorded communications to a file locally or via a communication link. The Print sub-menu would allow one to print the entire or a portion of the recorded meeting. The Email sub-menu would allow emailing the meeting data through the Internet. The Fax sub-menu would be used to enter or select Fax numbers for the destination.

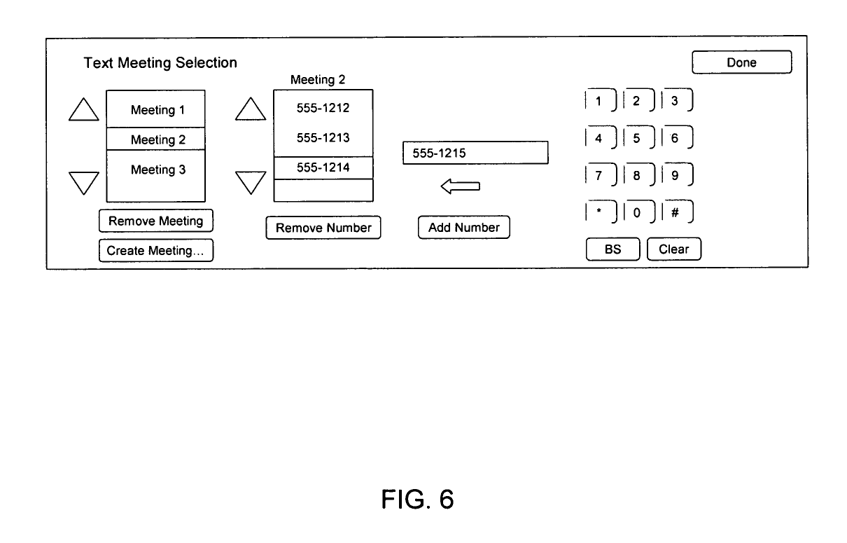

FIG. 6 is a diagram illustrating an example MFP menu by which a user may edit meeting lists when operating the MFP to record a meeting held via SMS test message. The meeting participants use the short message service (SMS) test message via wireless telephones to communicate to each other. For direct SMS text communications between meeting participants, the MFP may be added as a recipient for the text messages sent by each meeting participant. The MFP may record the text conversation and make it available to meeting participants after the text conversation.

As discussed above in FIG. 4, the MFP may capture more than one meeting at the same time, so the text message received by the MFP needs to be directed to the correct meeting. The caller ID (e.g. phone numbers) on the incoming message may be used by the MFP to direct the text message to the correct meeting. As illustrated in FIG. 6, the user may create or remove a meeting. For each meeting, the user may edit a list of caller IDs identifying the meeting participants.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A method of processing, at a multi-function peripheral (MFP), a meeting among a plurality of meeting participants, comprising:
recording at a MFP data indicative of a communication between or among a plurality of meeting participants, each meeting participant having an associated device to transmit data to others and to receive data transmitted from others,
wherein a copy of the transmitted data is provided to the MFP for recording when one of the meeting participants transmits data to other meeting participants.

2. The method of claim 1, wherein the meeting data comprises data obtained from at least one of the following: an Internet chat, a short message service, a telephone conference call, a video conference, communicating paging devices, walkie-talkies, and communicating Bluetooth headset devices.

3. The method of claim 1, wherein the meeting data comprises data obtained from a short message service, wherein the recording comprises:
for each transmission of data during the meeting,
receiving transmitted data from one user; and
accepting the transmitted data if the user sending the data is in a list of the meeting participants.

4. The method of claim 1, further comprising saving a composite of communication recordings as a recorded meeting at the MFP after receiving a request to end recording.

5. The method of claim 4, further comprising printing the recorded meeting at the MFP.

6. The method of claim 4, wherein the saving comprises saving substantially the entire set of meeting data in one computer-readable file at the MFP.

7. The method of claim 4, wherein the request to end recording is received from one of the meeting participants.

8. The method of claim 4, wherein the recorded meeting is saved to a persistent data storage.

9. The method of claim 1, further comprising distributing copies of the recorded meeting from the MFP to other devices.

10. The method of claim 9, wherein the distributing is performed via either email or facsimile.

11. The method of claim 1, further comprising connecting the MFP to the device of at least one meeting participant.

12. The method of claim 11, further comprising receiving an invitation to join a meeting, wherein the connecting comprises accepting the invitation to join a meeting.

13. The method of claim 12, wherein the invitation is not accepted if a list of pre-determined conditions is not met.

14. A multi-function peripheral (MFP) device configured to record a meeting among a plurality of meeting participants, each meeting participant having an associated device to transmit data to others and to receive data transmitted from others, comprising:
an input interface for receiving data from a user;
a display for providing information to the user;
a communication module configured to receive data transmitted from the meeting participants during the meeting via a communication link; and
a control unit executing a software application to control the input interface and the display to realize user interaction and to record data received from the communication module,
wherein a copy of the transmitted data is provided to the MFP for recording when one of the meeting participants transmits data to other meeting participants,
wherein a composite of recorded communications is saved as a recorded meeting at the MFP.

15. The device of claim 14, further comprising a storage module configured to save the recorded meeting.

16. The device of claim 15, wherein the storage module comprises a persistent data storage device.

17. The device of claim 14, wherein the meeting data comprises data obtained from at least one of the following: an Internet chat, a short message service, a telephone conference call, a video conference, communicating paging devices, walkie-talkies, and communicating Bluetooth headset devices.

18. The device of claim 14, further comprising a printing module configured to print the recorded meeting at the MFP.

19. The device of claim 14, wherein the communication module is further configured to distribute copies of the recorded meeting communications from the MFP.

20. The device of claim 19, wherein the communication module is configured to distribute the recorded meeting via either email or facsimile.

21. The device of claim 14, wherein the control unit is further configured to control the operation of the communication module to connect to at least one meeting participant.

22. A multi-function peripheral (MFP) device configured to record a meeting among a plurality of meeting participants, each meeting participant having an associated device to transmit data to others and to receive data transmitted from others, comprising:
means for receiving data transmitted from the meeting participants during a meeting; and
means for recording the received data at the MFP,
wherein a copy of the transmitted data is provided to the MFP for recording when a meeting participant transmits data to other meeting participants.

23. The device of claim 22, further comprising means for saving a composite of communication recordings as a recorded meeting.

24. The device of claim 23, wherein the saving means comprises a persistent data storage.

25. The device of claim 22, wherein the meeting data comprises data obtained from at least one of the following: an Internet chat, a short message service, a telephone conference call, a video conference, communicating paging devices, walkie-talkies, and communicating Bluetooth headset devices.

26. The device of claim 22, further comprising means for printing the recorded meeting at the MFP.

27. The device of claim 22, wherein the receiving means further comprises means for distributing copies of the recorded meeting communications from the MFP.

28. The device of claim 22, wherein the receiving means further comprises means for distributing copies of the recorded meeting communications from the MFP via either email or facsimile.
